(19) United States
(12) Patent Application Publication
(10) Pub. No.: US 2024/0300614 A1
(43) Pub. Date: Sep. 12, 2024

(54) Bicycle Crank

(71) Applicant: WindNer Carbon Tech Co., Ltd., Taichung City (TW)

(72) Inventor: Cheng Kai YANG, Taichung City (TW)

(21) Appl. No.: 18/592,166

(22) Filed: Feb. 29, 2024

(30) Foreign Application Priority Data
Mar. 9, 2023 (TW) 112202081

(51) Int. Cl. B62M 3/00

(52) U.S. Cl. CPC B62M 3/00

(57) ABSTRACT

The invention discloses a bicycle crank comprising a first connecting seat, a second connecting seat, a first connecting arm and a second connecting arm, the first connecting seat is connected to an external toothed disc or rotating shaft; the second connecting seat is spaced apart from the first connecting seat and is connected with an external pedal pivotally; the first connecting arm and the second connecting arm are respectively made by fiber winding technology and hot press molding, and have a predetermined length, and the first connecting arm and the second connecting arm are spaced apart from each other and respectively bridged between the first connecting seat and the second connecting seat to connect the first connecting seat with the second connecting seat.

### FIELD OF THE INVENTION

The invention relates to bicycles, and more particularly to a bicycle crank.

### DESCRIPTION OF THE RELATED ART

For the bicycle industry, in the manufacturing process of conventional carbon fiber cranks, manpower is mainly used to laminate carbon fibers layer by layer. Although it can produce cranks that are light in weight and have good structural strength, the manufacturing process of lamination by manpower is too lengthy, which will consume a lot of manufacturing time and increase manufacturing costs. As a result, the prices of carbon fiber cranks remain high, which reduces consumers' desire to purchase.

### SUMMARY OF THE INVENTION

A main object of the invention is to provide a bicycle crank that is pre-shaped using fiber winding technology and then directly put into a mold and hot-pressed, eliminating the conventional manual lamination process to reduce manufacturing time and labor costs.

Another object of the invention is to provide a bicycle crank which has a simple structure, is easy to assemble, and can be quickly assembled.

In order to achieve the above objects, the bicycle crank disclosed by the invention comprises a first connecting seat, a second connecting seat, a first connecting arm and a second connecting arm, wherein the first connecting seat is connected to an external toothed disc or rotating shaft; the second connecting seat is spaced apart from the first connecting seat and is connected with an external pedal pivotally; the first connecting arm and the second connecting arm are respectively made by fiber winding technology and hot press molding, and have a predetermined length, and the first connecting arm and the second connecting arm are spaced apart from each other and respectively bridged between the first connecting seat and the second connecting seat to connect the first connecting seat with the second connecting seat.

In one embodiment, the first connecting seat comprises a first body part, and the first body part comprises a first body and a first coating layer covering the first body.

In one embodiment, a material of the first coating layer is carbon fiber.

In one embodiment, a material of the first body is aluminum alloy.

In one embodiment, the first connecting arm is divided into a first coupling end, a first connecting section and a second coupling end according to extending directions thereof, and the first connecting section is provided between the first coupling end and the second coupling end; the second connecting arm is divided into a third coupling end, a second connecting section and a fourth coupling end according to extending directions thereof, and the second connecting section is provided between the third coupling end and the fourth coupling end.

In one embodiment, the first coupling end and the second coupling end are respectively connected to two sides of the first connecting section obliquely relative to the first connecting section, so that the first coupling end and the second coupling end are not on a same plane; the third coupling end and the fourth coupling end are respectively connected to two sides of the second connecting section obliquely relative to the second connecting section, so that the third coupling end and the fourth coupling end are not on a same plane.

In one embodiment, the first coupling end and the second coupling end are respectively inclined at a first angle with an extending direction of the first connecting section, so that extending directions of the first coupling end and the second coupling end are parallel to each other; the third coupling end and the fourth coupling end are respectively inclined at a second angle with an extending direction of the second connecting section, so that extending directions of the third coupling end and the fourth coupling end are parallel to each other.

In one embodiment, the first connecting seat further comprises a first pivot hole, a first end face, a first coupling hole and a second coupling hole, wherein the first pivot hole penetrates the first body part for connecting with the toothed disc or the rotating shaft; the first end face is located on a side of the first body part away from the first pivot hole; the first coupling hole extends recessedly from the first end face toward the first body part internally, the first coupling hole is not communicated with the first pivot hole, and the first coupling end of the first connecting arm is inserted into the first coupling hole; the second coupling hole is spaced apart from the first coupling hole and extends recessedly from the first end face toward the first body part internally, the second coupling hole is not communicated with the first pivot hole, and the third coupling end of the second connecting arm is inserted into the second coupling hole.

In one embodiment, the first coupling hole and the second coupling hole are rectangular, and extending directions of long sides thereof are perpendicular to each other.

In one embodiment, the second connecting seat comprises a second body part, and the second body part comprises a second body and a second coating layer covering the second body.

In one embodiment, a material of the second coating layer is carbon fiber.

In one embodiment, a material of the second body is aluminum alloy.

In one embodiment, the second connecting seat further comprises a second pivot hole, a second end face, a third coupling hole and a fourth coupling hole, wherein the second pivot hole penetrates the second body part for connecting with the pedal pivotally; the second end face is located on a side of the second body part away from the second pivot hole; the third coupling hole extends recessedly from the second end face toward the second body part internally, the third coupling hole is not communicated with the second pivot hole, and the second coupling end of the first connecting arm is inserted into the third coupling hole; the fourth coupling hole is spaced apart from the third coupling hole and extends recessedly from the second end face toward the second body part internally, the fourth coupling hole is not communicated with the second pivot hole, and the fourth coupling end of the second connecting arm is inserted into the fourth coupling hole.

In one embodiment, the third coupling hole and the fourth coupling hole are rectangular, and extending directions of long sides thereof are perpendicular to each other.

In one embodiment, a virtual first outer common tangent and a virtual second outer common tangent are provided between the first pivot hole and the second pivot hole, a hole axis direction of the first coupling hole and a hole axis direction of the third coupling hole are respectively parallel to the first outer common tangent, and a hole axis direction of the second coupling hole and a hole axis direction of the fourth coupling hole are respectively parallel to the second outer common tangent.

### BRIEF DESCRIPTION OF DRAWINGS

FIG. 1 is a perspective assembly view of a preferred embodiment of the invention.

FIG. 2 is an exploded perspective view of a preferred embodiment of the invention.

FIG. 3 is a perspective view of a second connecting seat of a preferred embodiment of the invention.

FIG. 4 is a cross-sectional view along section line 4-4 of FIG. 3.

FIG. 5 is a perspective view of a first connecting seat of a preferred embodiment of the invention.

FIG. 6 is a cross-sectional view along section line 6-6 of FIG. 5.

FIG. 7 is a side view of a first connecting arm of a preferred embodiment of the invention.

FIG. 8 is a side view of a second connecting arm of a preferred embodiment of the invention.

FIG. 9 is a side view of a preferred embodiment of the invention.

### DETAILED DESCRIPTION OF THE INVENTION

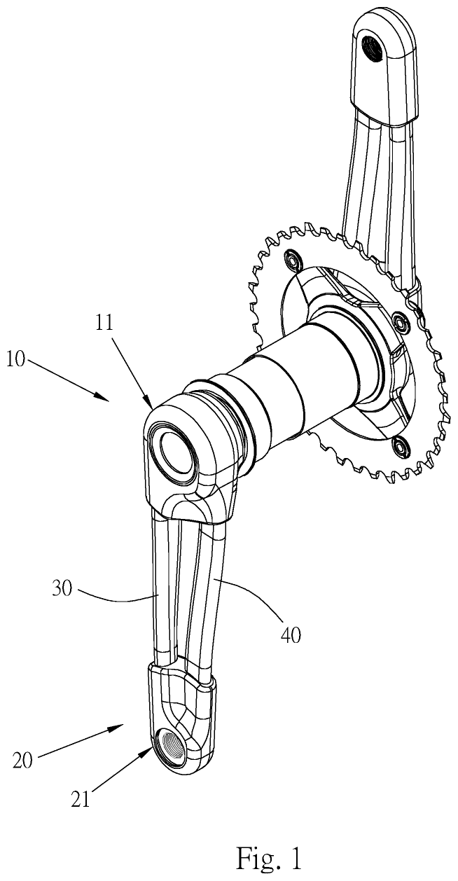

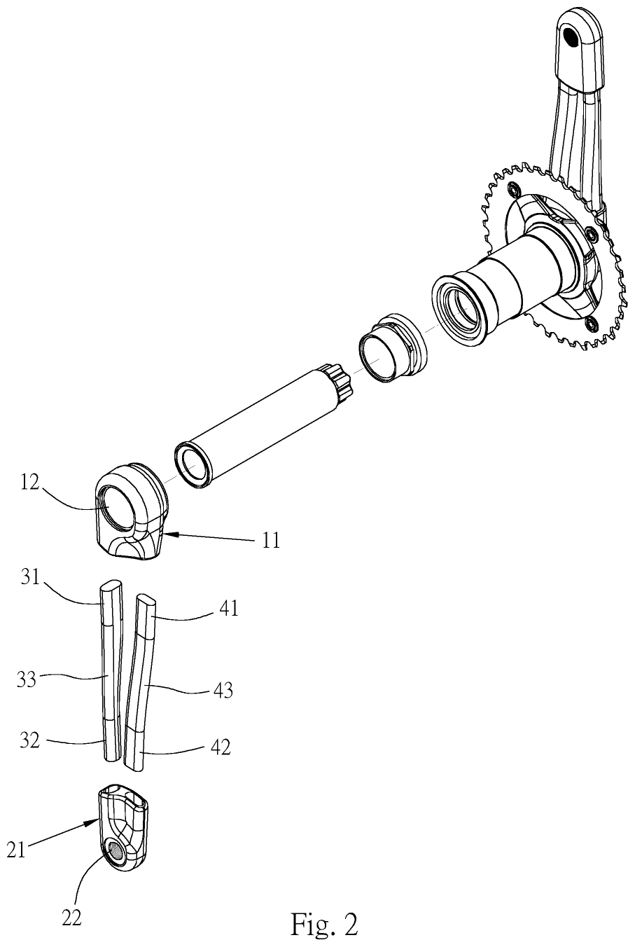

Please refer to FIGS. 1 to 8, a bicycle crank disclosed in a preferred embodiment of the invention comprises a first connecting seat 10, a second connecting seat 20, a first connecting arm 30 and a second connecting arm 40.

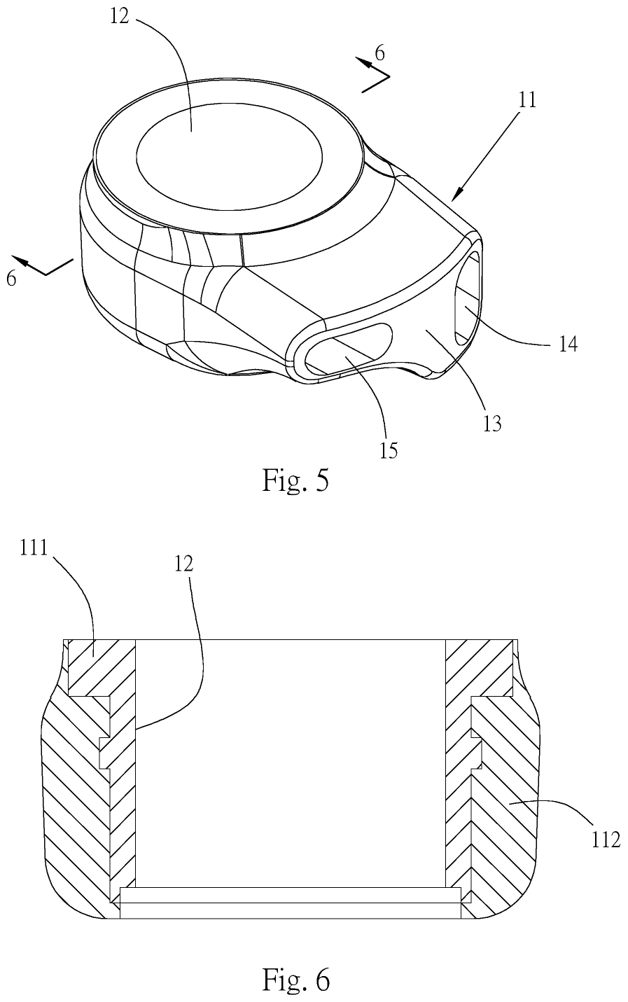

As shown in FIGS. 5 and 6, the first connecting seat 10 comprises a first body part 11, a first pivot hole 12, a first end face 13, a first coupling hole 14 and a second coupling hole 15. Wherein the first body part 11 comprises a first body 111 and a first coating layer 112. A material of the first body 111 is aluminum alloy, and a material of the first coating layer 112 is carbon fiber and is covered on the first body 111. In detail, the first body 111 and carbon fiber for coating a base material are placed in a first mold, and then heated and pressurized, so that the heated carbon fiber flows according to a shape of the first mold and is coated on the first body 111 to solidify and form the first coating layer 112. Therefore, the first connecting seat 10 has characteristics of both metal and carbon fiber, and can be used as a pivot structure capable of withstanding high torsion.

The first pivot hole 12 penetrates the first body part 11 for connecting with an external toothed disc or rotating shaft. The first end face 13 is located on a side of the first body part 11 away from the first pivot hole 12. The first coupling hole 14 extends recessedly from the first end face 13 toward the first body part 11 internally, and the first coupling hole 14 is not communicated with the first pivot hole 12. The second coupling hole 15 is spaced apart from the first coupling hole 14 and extends recessedly from the first end face 13 toward the first body part 11 internally, and the second coupling hole 15 is not communicated with the first pivot hole 12. In other feasible implementation modes, positions and hole diameters of the first pivot hole 12, the first coupling hole 14 and the second coupling hole 15 can be arbitrarily changed and adjusted according to actual requirements.

In addition, the first coating layer 112 in this embodiment is kept away from opening peripheries and hole inner walls of the first pivot hole 12, the first coupling hole 14 and the second coupling hole 15. In other feasible implementation modes, the first coating layer 112 can also be appropriately covered on opening peripheries and hole inner walls of the first pivot hole 12, the first coupling hole 14 and the second coupling hole 15 according to actual requirements.

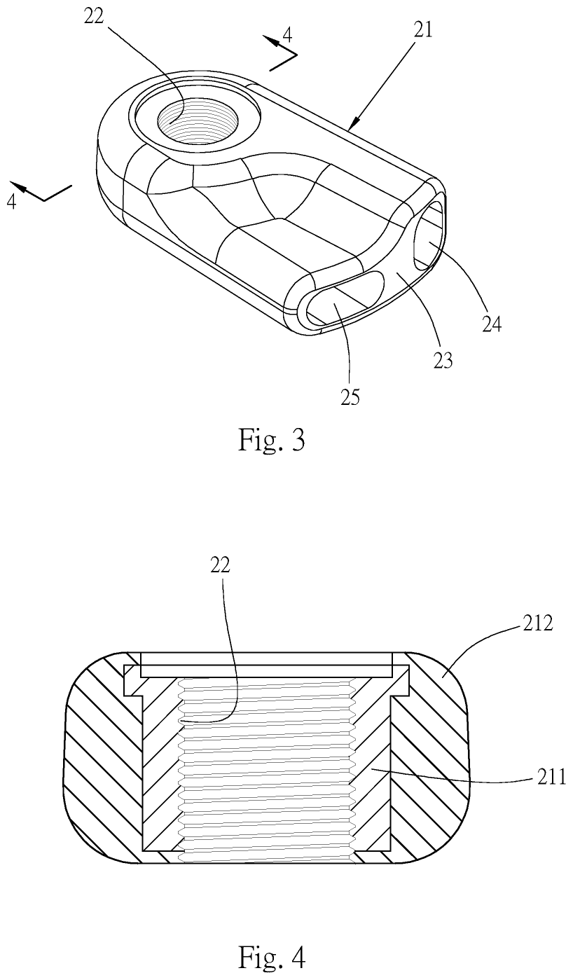

As shown in FIGS. 3 and 4, the second connecting seat 20 is spaced apart from the first connecting seat 10 and comprises a second body part 21, a second pivot hole 22, a second end face 23, a third coupling hole 24 and a fourth coupling hole 25. Wherein the second body part 21 comprises a second body 211 and a second coating layer 212. A material of the second body 211 is aluminum alloy, and a material of the second coating layer 212 is carbon fiber and is covered on the second body 211. In detail, the second body 211 and carbon fiber for coating a base material are placed in a second mold, and then heated and pressurized, so that the heated carbon fiber flows according to a shape of the second mold and is coated on the second body 211 to solidify and form the second coating layer 212. Therefore, the second connecting seat 20 has characteristics of both metal and carbon fiber, and can be used as a pivot structure capable of withstanding high torsion.

The second pivot hole 22 penetrates the second body part 21 for connecting with an external pedal pivotally. The pedal and its connection method are conventional technologies and are not the focus of the invention, so they will not be described herein. The second end face 23 is located on a side of the second body part 21 away from the second pivot hole 22. The third coupling hole 24 extends recessedly from the second end face 23 toward the second body part 21 internally, and the third coupling hole 24 is not communicated with the second pivot hole 22. The fourth coupling hole 25 is spaced apart from the third coupling hole 24 and extends recessedly from the second end face 23 toward the second body part 21 internally, and the fourth coupling hole 25 is not communicated with the second pivot hole 22. In other feasible implementation modes, positions and hole diameters of the second pivot hole 22, the third coupling hole 24 and the fourth coupling hole 25 can be arbitrarily changed and adjusted according to actual requirements.

In addition, the second coating layer 212 in this embodiment is kept away from opening peripheries and hole inner walls of the second pivot hole 22, the third coupling hole 24 and the fourth coupling hole 25. In other feasible implementation modes, the second coating layer 212 can also be appropriately covered on opening peripheries and hole inner walls of the second pivot hole 22, the third coupling hole 24 and the fourth coupling hole 25 according to actual requirements.

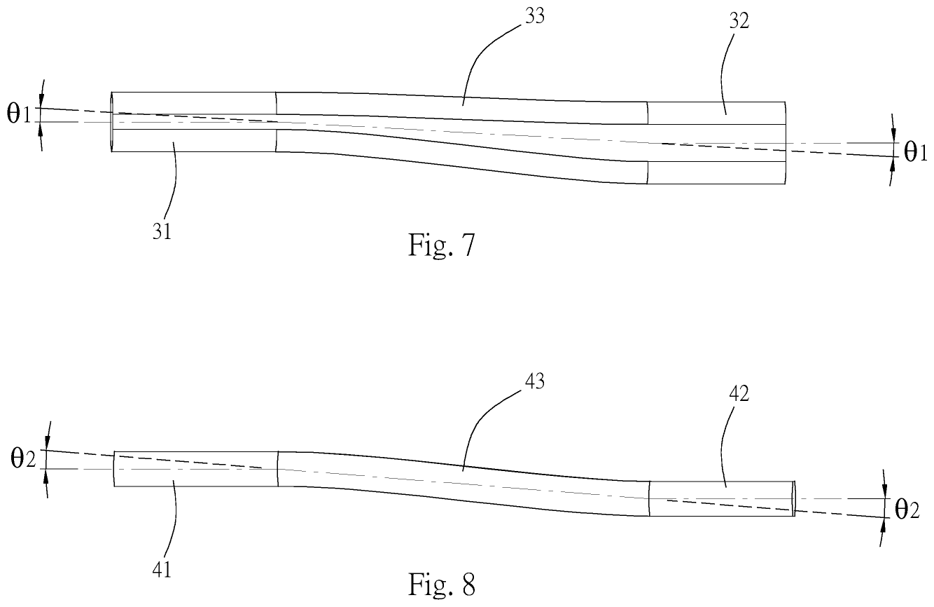

The first connecting arm 30 and the second connecting arm 40 are respectively made by fiber winding technology and hot press molding, and have a predetermined length, and the length can be changed according to specifications and dimensions designed for manufacturing. In detail, as shown in FIG. 7, the first connecting arm 30 is divided into a first coupling end 31, a first connecting section 32 and a second coupling end 33 according to extending directions thereof, and the first connecting section 32 is provided between the first coupling end 31 and the second coupling end 33. Furthermore, the first coupling end 31 and the second coupling end 33 are respectively connected to two sides of the first connecting section 32 obliquely at a first angle θ1 with an extending direction of the first connecting section 32, so that the first coupling end 31 and the second coupling end 33 are located on different planes, and extending directions of the first coupling end 31 and the second coupling end 33 are parallel to each other.

As shown in FIG. 8, the second connecting arm 40 is divided into a third coupling end 41, a second connecting section 42 and a fourth coupling end 43 according to extending directions thereof, and the second connecting section 42 is provided between the third coupling end 41 and the fourth coupling end 43. Furthermore, the third coupling end 41 and the fourth coupling end 43 are respectively connected to two sides of the second connecting section 42 obliquely at a second angle θ2 with an extending direction of the second connecting section 42, so that the third coupling end 41 and the fourth coupling end 43 are located on different planes, and extending directions of the third coupling end 41 and the fourth coupling end 43 are parallel to each other.

When the invention is in an assembled state, in order to achieve an object of secure combination, the first coupling hole 14, the second coupling hole 15, the third coupling hole 24 and the fourth coupling hole 25 are respectively rectangular, and the first connecting arm 30 and the second connecting arm 40 are designed into a substantially flat plate structure corresponding to shapes of the coupling holes, so that the first coupling end 31 of the first connecting arm 30 is inserted into the first coupling hole 14, the third coupling end 41 of the second connecting arm 40 is inserted into the second coupling hole 15, the second coupling end 33 of the first connecting arm 30 is inserted into the third coupling hole 24, and the fourth coupling end 43 of the second connecting arm 40 is inserted into the fourth coupling hole 25. Furthermore, an adhesive is used to combine the first connecting arm 30 and the second connecting arm 40 with the first connecting seat 10 and the second connecting seat 20 respectively, so that the components of the bicycle crank of the invention can be securely connected to one another.

In other feasible implementation modes, overall shapes of the first connecting arm 30 and the second connecting arm 40 can also be changed to an arc shape, a curved shape or a tapered shape according to requirements, and the design of plate structure can also be changed to round tube, square tube or other long columnar structures of any shape, and can also be used as components for fixing and bridging. Furthermore, the first coupling hole 14 and the second coupling hole 15 can also be in the shape of a rhombus, a polygon, a star, a quincunx, and the coupling ends of the first connecting arm 30 and the second connecting arm 40 can also be changed to corresponding shapes to achieve an object of secure combination.

In addition, in this embodiment, extending directions of long sides of the rectangular first coupling hole 14 and second coupling hole 15 are perpendicular to each other, extending directions of long sides of the rectangular third coupling hole 24 and fourth coupling hole 25 are perpendicular to each other, and the first coupling hole 14 and the third coupling hole 24, and the second coupling hole 15 and the fourth coupling hole 25 are opposite to each other in pairs. Accordingly, when the first connecting arm 30 and the second connecting arm 40 in the form of a flat plate are assembled on the first connecting seat 10 and the second connecting seat 20 respectively, there are different installation angles in cooperation with designs of the first coupling hole 14, the second coupling hole 15, the third coupling hole 24 and the fourth coupling hole 25. Since the first connecting arm 30 and the second connecting arm 40 are flat plate structures, thicknesses thereof in X-axis and Y-axis directions are different, thereby respectively increasing acting forces that can be withstood in different axial directions to enhance a structural strength of the bicycle crank of the invention.

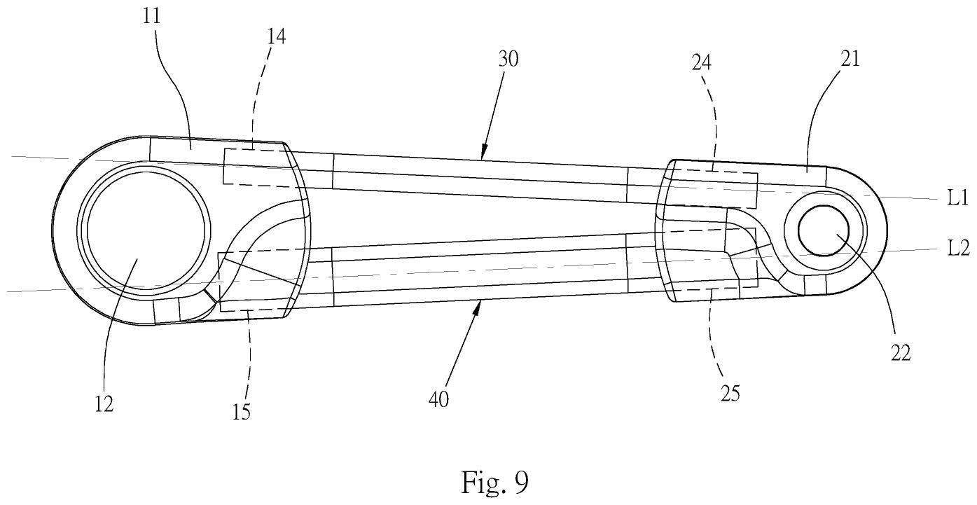

As shown in FIG. 9, a virtual first outer common tangent L1 and a virtual second outer common tangent L2 are provided between the first pivot hole 12 and the second pivot hole 22, a hole axis direction of the first coupling hole 14 and a hole axis direction of the third coupling hole 24 are respectively parallel to the first outer common tangent L1, and a hole axis direction of the second coupling hole 15 and a hole axis direction of the fourth coupling hole 25 are respectively parallel to the second outer common tangent L2.

Summing up the above, the bicycle crank of the invention not only has a simple structure, is easy to assemble, and can be assembled quickly, the components thereof are pre-shaped using fiber winding technology and can be directly put into a mold and hot-pressed, eliminating the conventional manual lamination process to achieve efficacies of reducing manufacturing time and labor costs.

Although the invention has been disclosed as above with the embodiments, it is not intended to limit the invention. A person having ordinary skill in the art to which the invention pertains can make various changes and modifications without departing from the spirit and scope of the invention. Therefore, scope of protection of the invention shall be subject to what is defined in the pending claims.

What is claimed is:

1. A bicycle crank comprising:
a first connecting seat connected to an external toothed disc or rotating shaft;
a second connecting seat spaced apart from the first connecting seat and connecting with an external pedal pivotally; and
a first connecting arm and a second connecting arm respectively made by fiber winding technology and hot press molding, and having a predetermined length, and the first connecting arm and the second connecting arm being spaced apart from each other and respectively bridged between the first connecting seat and the second connecting seat to connect the first connecting seat with the second connecting seat.

2. The bicycle crank as claimed in claim 1, wherein the first connecting seat comprises a first body part, the first body part comprises:
a first body; and
a first coating layer covering the first body.

3. The bicycle crank as claimed in claim 2, wherein a material of the first coating layer is carbon fiber.

4. The bicycle crank as claimed in claim 2, wherein a material of the first body is aluminum alloy.

5. The bicycle crank as claimed in claim 2, wherein the first connecting arm is divided into a first coupling end, a first connecting section and a second coupling end according to extending directions thereof, and the first connecting section is provided between the first coupling end and the second coupling end; the second connecting arm is divided into a third coupling end, a second connecting section and a fourth coupling end according to extending directions thereof, and the second connecting section is provided between the third coupling end and the fourth coupling end.

6. The bicycle crank as claimed in claim 5, wherein the first coupling end and the second coupling end are respectively connected to two sides of the first connecting section obliquely relative to the first connecting section, so that the first coupling end and the second coupling end are not on a same plane; the third coupling end and the fourth coupling end are respectively connected to two sides of the second connecting section obliquely relative to the second connecting section, so that the third coupling end and the fourth coupling end are not on a same plane.

7. The bicycle crank as claimed in claim 6, wherein the first coupling end and the second coupling end are respectively inclined at a first angle with an extending direction of the first connecting section, so that extending directions of the first coupling end and the second coupling end are parallel to each other; the third coupling end and the fourth coupling end are respectively inclined at a second angle with an extending direction of the second connecting section, so that extending directions of the third coupling end and the fourth coupling end are parallel to each other.

8. The bicycle crank as claimed in claim 5, wherein the first connecting seat further comprises:
a first pivot hole penetrating the first body part for connecting with the toothed disc or the rotating shaft;
a first end face located on a side of the first body part away from the first pivot hole;
a first coupling hole extending recessedly from the first end face toward the first body part internally, the first coupling hole is not communicated with the first pivot hole, and the first coupling end of the first connecting arm is inserted into the first coupling hole; and
a second coupling hole spaced apart from the first coupling hole and extending recessedly from the first end face toward the first body part internally, the second coupling hole is not communicated with the first pivot hole, and the third coupling end of the second connecting arm is inserted into the second coupling hole.

9. The bicycle crank as claimed in claim 8, wherein the first coupling hole and the second coupling hole are rectangular, and extending directions of long sides thereof are perpendicular to each other.

10. The bicycle crank as claimed in claim 8, wherein the second connecting seat comprises a second body part, the second body part comprises:
a second body; and
a second coating layer covering the second body.

11. The bicycle crank as claimed in claim 10, wherein a material of the second coating layer is carbon fiber.

12. The bicycle crank as claimed in claim 11, wherein a material of the second body is aluminum alloy.

13. The bicycle crank as claimed in claim 10, wherein the second connecting seat further comprises:
a second pivot hole penetrating the second body part for connecting with the pedal pivotally;
a second end face located on a side of the second body part away from the second pivot hole;
a third coupling hole extending recessedly from the second end face toward the second body part internally, the third coupling hole is not communicated with the second pivot hole, and the second coupling end of the first connecting arm is inserted into the third coupling hole; and
a fourth coupling hole spaced apart from the third coupling hole and extending recessedly from the second end face toward the second body part internally, the fourth coupling hole is not communicated with the second pivot hole, and the fourth coupling end of the second connecting arm is inserted into the fourth coupling hole.

14. The bicycle crank as claimed in claim 13, wherein the third coupling hole and the fourth coupling hole are rectangular, and extending directions of long sides thereof are perpendicular to each other.

15. The bicycle crank as claimed in claim 14, wherein a virtual first outer common tangent and a virtual second outer common tangent are provided between the first pivot hole and the second pivot hole, a hole axis direction of the first coupling hole and a hole axis direction of the third coupling hole are respectively parallel to the first outer common tangent, and a hole axis direction of the second coupling hole and a hole axis direction of the fourth coupling hole are respectively parallel to the second outer common tangent.

16. The bicycle crank as claimed in claim 3, wherein the first connecting arm is divided into a first coupling end, a first connecting section and a second coupling end according to extending directions thereof, and the first connecting section is provided between the first coupling end and the second coupling end; the second connecting arm is divided into a third coupling end, a second connecting section and a fourth coupling end according to extending directions thereof, and the second connecting section is provided between the third coupling end and the fourth coupling end.

17. The bicycle crank as claimed in claim 4, wherein the first connecting arm is divided into a first coupling end, a first connecting section and a second coupling end according to extending directions thereof, and the first connecting section is provided between the first coupling end and the second coupling end; the second connecting arm is divided into a third coupling end, a second connecting section and a fourth coupling end according to extending directions thereof, and the second connecting section is provided between the third coupling end and the fourth coupling end.
